(19) United States
(12) Patent Application Publication
(10) Pub. No.: US 2017/0255565 A1
(43) Pub. Date: Sep. 7, 2017

(54) METHOD AND APPARATUS FOR PROVIDING A CONTIGUOUSLY ADDRESSABLE MEMORY REGION BY REMAPPING AN ADDRESS SPACE

(71) Applicant: Intel Corporation, Santa Clara, CA (US)

(72) Inventors: Stanislaw Mosiolek, Gdansk (PL); Tobiasz Domagala, Gdansk (PL)

(73) Assignee: Intel Corporation, Santa Clara, CA (US)

(21) Appl. No.: 15/058,422

(22) Filed: Mar. 2, 2016

(51) Int. Cl. G06F 12/10; G06F 3/06

(52) U.S. Cl. CPC G06F 12/1009; G06F 3/0604; G06F 3/0659; G06F 3/0683; G06F 2212/657

(57) ABSTRACT

In one embodiment, an apparatus comprises a memory device controller toreceive a command comprising an identification of a region of data stored in a memory and a request to change a location of the region of data. The memory device controller is further to request the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

### FIELD

The present disclosure relates in general to the field of computer development, and more specifically, to providing a contiguously addressable memory region by remapping an address space.

### BACKGROUND

A computer system may include one or more central processing units (CPUs) coupled to one or more memory devices. A CPU may include a processor to execute an operating system that utilizes memory devices coupled to the CPU. The operating system may perform various operations relating to the memory devices, such as allocating regions of memory of the memory devices, reading from the memory devices, and writing to the memory devices.

### BRIEF DESCRIPTION OF THE DRAWINGS

FIG. 1 illustrates a block diagram of components of a computer system in accordance with certain embodiments.

FIG. 2 illustrates an example flow for providing a contiguously addressable memory region without relocating data in accordance with certain embodiments.

FIG. 3 illustrates an example state of a memory device prior to processing a command to change the location of a region of data in accordance with certain embodiments.

FIG. 4 illustrates an example state of a memory device after a command to change the location of a region of data has been processed in accordance with certain embodiments.

FIG. 5 illustrates an example flow for issuing a command to change the location of a region of data in accordance with certain embodiments.

FIG. 6 illustrates an example flow for processing a command to change the location of a region of data in accordance with certain embodiments.

Like reference numbers and designations in the various drawings indicate like elements.

### DETAILED DESCRIPTION

Although the drawings depict particular computer systems, the concepts of various embodiments are applicable to any suitable integrated circuits and other logic devices. Examples of devices in which teachings of the present disclosure may be used include desktop computer systems, server computer systems, storage systems, handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications may include a microcontroller, a digital signal processor (DSP), a system on a chip, network computers (NetPC), set-top boxes, network hubs, wide area network (WAN) switches, or any other system that can perform the functions and operations taught below.

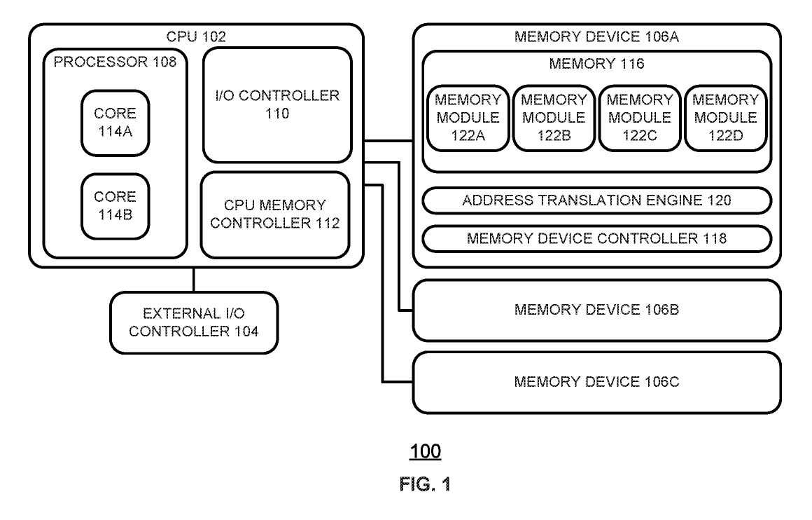

FIG. 1 illustrates a block diagram of components of a computer system 100 in accordance with certain embodiments. System 100 includes a central processing unit (CPU) 102 coupled to an external input/output (I/O) controller 104 and a plurality of memory devices 106. During operation, data may be transferred between memory devices 106 and the CPU 102. In various embodiments, particular data operations involving a memory device 106 may be managed by an operating system or other software executed by processor 108.

A memory device 106 may expose an externally addressable address space of its memory to the operating system. The operating system uses this address space to perform memory operations (e.g., reads and writes) with the memory device. For example, when identifying a region of data in association with a command to be sent to the memory device 106, the operating system may reference the region of data through at least one address (e.g., the start address and/or end address) of the region of data in the externally addressable address space. A memory device 106 also has a physical address space. In various embodiments, the physical address space is not exposed to the operating system. The physical address space includes the addresses that are applied directly to the memory (e.g., by manipulating voltages of signals provided to the memory to match the addresses) to read data from or write data to the memory. In various embodiments, in order to allow the operating system to interact with the memory, the addresses in the externally addressable address space are translated into addresses in the physical address space within the memory device 106.

Over time, as various memory operations are performed at the memory device, the memory of the memory device may become fragmented. Fragmentation of the memory results in a reduction of the largest contiguously addressable range of memory in the externally addressable address space.

In various embodiments, the operating system may receive a request for allocation of a contiguously addressable memory region that is larger than the largest available contiguously addressable memory region in the externally addressable address space. In such cases, the operating system may be able to manage the creation of a contiguously addressable memory region for the request by issuing a series of read and write commands to the memory device 106 to move data out of the desired region to another region in the externally addressable address space. Such commands would result in the physical movement of the data within the memory. While this method may allow the operating system to free up a contiguously addressable memory region in the externally addressable address space, the physical movement of the data may take an undesirably large amount of time, particularly when a large amount of data must be moved to obtain the requested contiguously addressable memory region.

Various embodiments of the present disclosure allow the mapping between the externally addressable address space of a memory device 106 and the physical memory space of the memory device to be modified in order to increase the size of the largest contiguously addressable memory region of the externally addressable address space without physically moving the data stored in the memory of the memory device. Various such embodiments may offer technical advantages including, for example, a reduction in the amount of time, communication bandwidth, and power required to free up a requested contiguously addressable memory region.

CPU 102 comprises a processor 108, such as a microprocessor, an embedded processor, a digital signal processor (DSP), a network processor, a handheld processor, an application processor, a co-processor, a system on a chip (SOC), or other device to execute code (i.e., software instructions). Processor 108, in the depicted embodiment, includes two processing elements (cores 114A and 114B in the depicted embodiment), which may include asymmetric processing elements or symmetric processing elements. However, a processor may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core 114 may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

In various embodiments, the processing elements may also include one or more arithmetic logic units (ALUs), floating point units (FPUs), caches, instruction pipelines, interrupt handling hardware, registers, or other hardware to facilitate the operations of the processing elements.

I/O controller 110 is an integrated I/O controller that includes logic for communicating data between CPU 102 and I/O devices, which may refer to any suitable devices capable of transferring data to and/or receiving data from an electronic system, such as CPU 102. For example, an I/O device may be an audio/video (A/V) device controller such as a graphics accelerator or audio controller; a data storage device controller, such as a flash memory device, magnetic storage disk, or optical storage disk controller; a wireless transceiver; a network processor; a network interface controller; or a controller for another input devices such as a monitor, printer, mouse, keyboard, or scanner; or other suitable device. In a particular embodiment, an I/O device may comprise a memory device 106 coupled to the CPU 102 through I/O controller 110.

An I/O device may communicate with the I/O controller 110 of the CPU 102 using any suitable signaling protocol, such as peripheral component interconnect (PCI), PCI Express (PCIe), Universal Serial Bus (USB), Serial Attached SCSI (SAS), Serial ATA (SATA), Fibre Channel (FC), IEEE 802.3, IEEE 802.11, or other current or future signaling protocol. In various embodiments, I/O devices coupled to the I/O controller may be located off-chip (i.e., not on the same chip as CPU 102) or may be integrated on the same chip as the CPU 102.

CPU memory controller 112 is an integrated memory controller that includes logic to control the flow of data going to and from the memory devices 106. CPU memory controller 112 may include logic operable to read from a memory device 106, write to a memory device 106, or to request other operations from a memory device 106 (such as a memory region location change as described herein). In various embodiments, CPU memory controller 112 may receive write requests from cores 114 and/or I/O controller 110 and may provide data specified in these requests to a memory device 106 for storage therein. CPU memory controller 112 may also read data from a memory device 106 and provide the read data to I/O controller 110 or a core 114. During operation, CPU memory controller 112 may issue commands including one or more addresses (e.g., row and/or column addresses) of the memory device 106 in order to read data from or write data to memory (or to perform other operations). The addresses used by the CPU memory controller 112 in such commands are addresses in the externally addressable address space of the memory device 106. In some embodiments, memory controller 112 may be implemented in the same die or integrated circuit as CPU 102, whereas in other embodiments, memory controller 112 may be implemented in a different die or integrated circuit than that of CPU 102.

The CPU 102 may also be coupled to one or more other I/O devices through external I/O controller 104. In a particular embodiment, external I/O controller 104 may couple a memory device 106 to the CPU 102. External I/O controller 104 may include logic to manage the flow of data between one or more CPUs 102 and I/O devices. In particular embodiments, external I/O controller 104 is located on a motherboard along with the CPU 102. The external I/O controller 104 may exchange information with components of CPU 102 using point-to-point or other interfaces.

A memory device 106 may store any suitable data, such as data used by processor 108 to provide functionality of computer system 100. For example, data associated with programs that are executed or files accessed by cores 114 may be stored in memory device 106. Thus, a memory device 106 may include a system memory that stores data and/or sequences of instructions that are used or executed by the cores 114. In various embodiments, a memory device 106 may store persistent data (e.g., a user's files) that remains stored even after power to the memory device 106 is removed. A memory device 106 may be dedicated to CPU 102 or shared with other devices (e.g., another CPU or other device) of computer system 100.

In various embodiments, a memory device 106 may include various regions of memory that are each located at a set of contiguous memory addresses. An address may be contiguous with another address if it points to the next addressable portion of memory, where a portion of memory may be any suitable size, such as a single cell, a byte, a word, a page, a block, etc. A region of memory that is located at a set of contiguous memory addresses may be termed a contiguously addressable memory region. If a contiguously addressable memory region is allocated to a particular entity, then each portion of memory referred to by the addresses within the contiguous set of addresses (from the start address to the end address) is allocated to that entity. A contiguously addressable memory region could be allocated in response to a request for, e.g., a namespace (e.g., a storage partition assigned to a drive letter), a block translation table arena, a memory space for a program running on an operating system, or other memory partition.

In the embodiment depicted, memory device 106A includes a memory 116 comprising a plurality of memory modules 122A-D (a memory device may include any suitable number of memory modules 122), memory device controller 118, and address translation engine 120. A memory module 122 includes a plurality of memory cells that are each operable to store one or more bits. The cells of a memory module 122 may be arranged in any suitable fashion, such as in columns and rows or three dimensional structures. The cells may be logically grouped into banks, blocks, pages (wherein a page is a subset of a block), frames, bytes, or other suitable groups.

A memory module 122 may include non-volatile memory and/or volatile memory. Non-volatile memory is a storage medium that does not require power to maintain the state of data stored by the medium. Nonlimiting examples of nonvolatile memory may include any or a combination of: solid state memory (such as planar or 3D NAND flash memory or NOR flash memory), 3D XPoint memory, memory devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D XPoint memory may comprise a transistor-less stackable cross point architecture in which memory cells sit at the intersection of words lines and bit lines and are individually addressable and in which bit storage is based on a change in bulk resistance. In particular embodiments, a memory module 122 with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module 122 is synchronous dynamic random access memory (SDRAM). In particular embodiments, DRAM of the memory modules 122 complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Such standards (and similar standards) may be referred to as DDR-based standards and communication interfaces of the memory devices 106 that implement such standards may be referred to as DDR-based interfaces.

Memory device 106 may have any suitable form factor. In a particular embodiment, memory device 106 has a dual in-line memory module (DIMM) form factor. A DIMM may include multiple memory modules 122 mounted on a circuit board that includes electrical contacts (i.e., pins) on each side of the circuit board. In various examples, the memory device 106 may have any suitable number of pins, such as 288, 260, 244, 240, 204, 200, or other suitable number of pins. In various embodiments, memory device 106 may be inserted into a DIMM slot on a circuit board (e.g., motherboard) that also comprises a socket for CPU 102. In a particular embodiment, memory device 106 is a non-volatile DIMM (NV-DIMM) in which the memory modules 122 include non-volatile memory and the device has a DIMM form factor.

In a particular embodiment, memory device 106 comprises non-volatile memory (e.g., flash memory, 3D XPoint memory) and includes a communication interface that is compatible with a DDR standard, such as any of those listed above. Accordingly, in one example, CPU 102 may communicate with such a memory device as if the memory device included DDR4 compatible SDRAM modules. That is, the CPU memory controller 112 would use the same format to communicate commands and data with the memory device as it would with a DDR4 compatible memory device comprising SDRAM. In a particular embodiment, the memory device 106 may be inserted into a DIMM slot that implements a DDR interface.

Memory devices 106 may comprise any suitable type of memory and are not limited to a particular speed or technology of memory in various embodiments. Memory devices 106 may include any suitable interface to communicate with CPU memory controller 112 or I/O controller 110 using any suitable communication protocol such as a DDR-based protocol, peripheral component interconnect (PCI), PCI Express (PCIe), Universal Serial Bus (USB), Serial Attached SCSI (SAS), Serial ATA (SATA), Fibre Channel (FC), System Management Bus (SMBus), or other suitable protocol. In particular embodiments, memory device 106 may comprise multiple communication interfaces that each communicate using a separate protocol with CPU memory controller 112 and/or I/O controller 110.

Memory device controller 118 may include logic to receive requests from CPU 102 (e.g., from memory controller 112 or I/O controller 110), cause the requests to be carried out with respect to memory 116, and provide data associated with the requests to CPU 102 (e.g., from memory controller 112 or I/O controller 110). Controller 118 may also be operable to detect and/or correct errors encountered during memory operation. In an embodiment, controller 118 also tracks the number of times particular cells (or logical groupings of cells) have been written to in order to perform wear leveling and/or to detect when cells are nearing an estimated number of times they may be reliably written to. In various embodiments, controller 118 may also monitor various characteristics of the memory device 106 such as the temperature or voltage and report associated statistics to the CPU 102. Controller 118 can be implemented in the same or different die or circuit as that or those of memory 116.

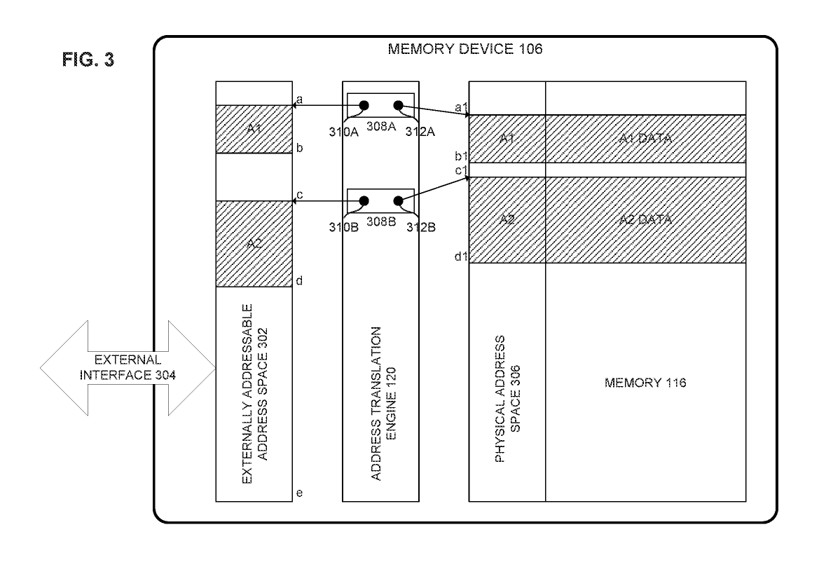

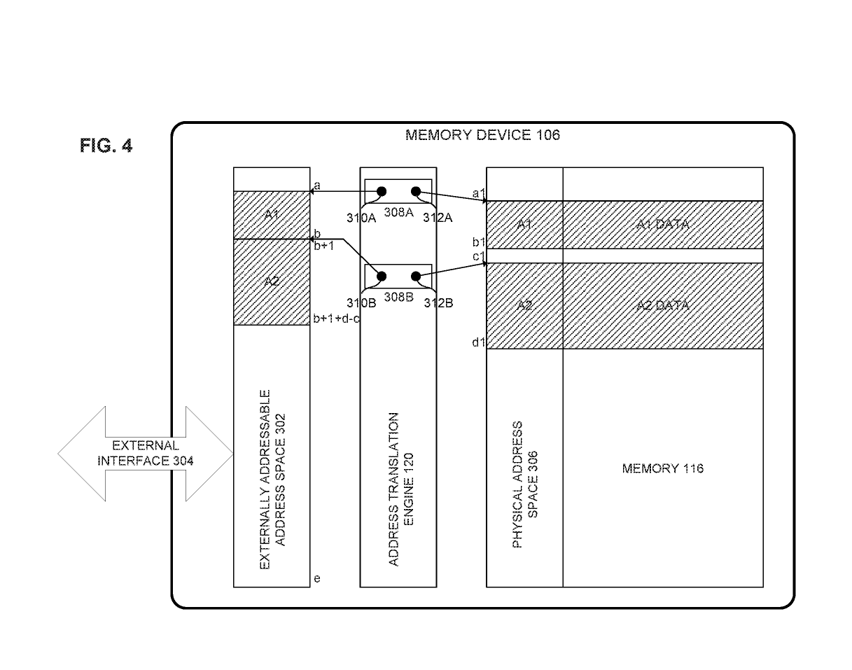

In various embodiments, the memory device 106 also includes an address translation engine 120. In various embodiments, the address translation engine 120 may be included within the memory device controller 118 (e.g., integrated on the same chip as the memory device controller 118) or may be separate from the memory device controller 118. Address translation engine 120 includes logic to store and update a mapping between the externally addressable address space and the physical address space of the memory 116. Address translation engine 120 comprises a plurality of mapping entries that each map one or more addresses in the externally addressable address space to one or more addresses in the physical address space. The address translation engine 120 may include any suitable memory type for storing the mapping entries and any suitable logic for changing values stored in the mapping entries (e.g., in response to a request from the memory device controller 118) and reading values from the mapping entries (e.g., to provide the values to the memory device controller 118 for use in memory operations). The mapping entries will be explained in further detail in connection with FIGS. 3 and 4.

In various embodiments, the address translation engine 120 is also used to prevent the use of bad memory cells (or logical grouping of cells) by not allowing physical addresses for the bad cells (or logical grouping of cells) to be mapped to the externally addressable address space. In various embodiments, the address translation engine 120 (in conjunction with the memory device controller 118) may also provide wear leveling through management of the mappings of the address translation engine 120.

In some embodiments, all or some of the elements of system 100 are resident on (or coupled to) the same circuit board (e.g., a motherboard). In various embodiments, any suitable partitioning between the elements may exist. For example, the elements depicted in CPU 102 may be located on a single die or package (i.e., on-chip) or any of the elements of CPU 102 may be located off-chip.

The components of system 100 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, and a Gunning transceiver logic (GTL) bus. In various embodiments an integrated I/O subsystem includes point-to-point multiplexing logic between various components of system 100, such as cores 114, one or more CPU memory controllers 112, I/O controller 110, integrated I/O devices, direct memory access (DMA) logic (not shown), etc.

Although not depicted, system 100 may use a battery and/or power supply outlet connector and associated system to receive power.

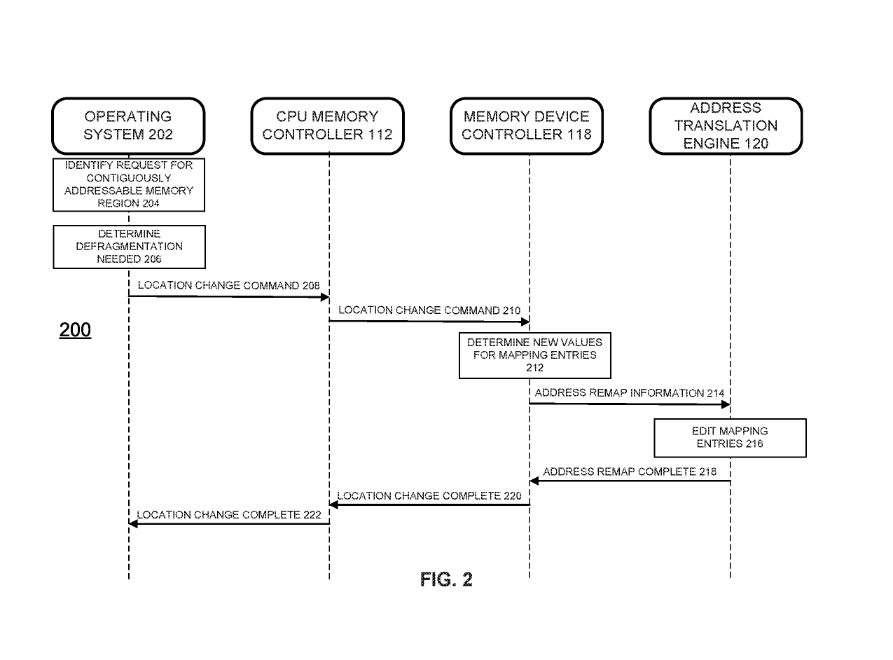

FIG. 2 illustrates an example flow 200 for providing a contiguously addressable memory region without relocating data in accordance with certain embodiments. The flow 200 depicts example operations that may be performed by an operating system 202, CPU memory controller 112, memory device controller 118, and address translation engine 120. The elements shown in the flow are examples only and in other embodiments, other elements could perform the depicted operations (e.g., I/O controller 110 could perform the operations of CPU memory controller 112).

At 204, the operating system identifies a request for a contiguously addressable memory region. The request may be generated in any suitable manner. For example, the request may be received from a user application being run by the operating system or may be generated by the operating system in response to a detected need (or anticipated future need) for the contiguously addressable memory region (e.g., a user may request a partition of data via the operating system). In various embodiments, the request may be for a new region of data or for an increase of size of an existing region. The request may indicate a particular size (e.g., a number of bytes) for the contiguously addressable memory region. In some embodiments, the request may indicate (or otherwise include information allowing the derivation of) an address of the externally addressable address space at which the contiguously addressable memory region is to start and/or end (e.g., if the request is to extend an existing contiguously addressable memory region already allocated to a namespace, application, or other element).

At 206, the operating system determines that defragmentation of the externally addressable address space is used in order allocate the requested contiguously addressable memory region. That is, the operating system may determine that the externally addressable address space does not include a contiguously addressable memory region that is unused and large enough to accommodate the request. The operating system may then select one or more regions of the externally addressable address space to be moved within the externally addressable address space in order to free up a contiguously addressable memory region for the request.

At 208, the operating system generates a location change command and sends the command to the CPU memory controller 112. A location change command may refer to a command to be sent to a memory device 106 that requests the movement of a region (or multiple regions) of the externally addressable address space to a different region (or multiple different regions) of the externally addressable address space. In various embodiments, movement of a region within the externally addressable address space may refer to modifying a set of one or more addresses (in the externally addressable address space) that may be used by the operating system to access a data region. Thus, prior to the movement of the data region within the externally addressable address space, a first set of addresses may be used by the operating system to access the data region and after the movement a second set of addresses (different from the first set of addresses) is used by the operating system to access the same data region. In various embodiments, the operating system may be agnostic as to whether a location change command results in the data region being physically moved within the memory 116 (which in some embodiments could include maintaining the source region for eventual overwriting) or whether the memory device 106 performs remapping of a portion of the externally addressable address space to the physical address space (without moving the underlying data stored in memory) in order to allow the operating system to use a different set of addresses to reference the data region. The location change command may include any suitable information, such as a start address of a region to be moved, an end address of the region to be moved, a size of a region to be remapped (which is the same as the size of the new region to which the region is being moved), a start address of the new region to which the region is being moved, an end address of the new region to which the region is being moved, any other identifier facilitating the change of the location of a region, or any suitable combination thereof.

In various embodiments, the operating system or a user thereof may be unaware that the location change command will trigger a remapping between the externally addressable address space and the physical address space (e.g., the operating system or a user thereof may be under the impression that the region of data identified in the location change command is to be physically moved from a location of memory 116 to a different location of memory 116). In another embodiment, the operating system may be aware that the location change command will trigger a remapping between the externally addressable address space and the physical address space.

In various embodiments, the location change command may be generated by a software driver (that may or may not be part of the operating system) that is configured to translate a generic command (e.g., a command to move data) received from a portion of the operating system that calls the driver into one or more commands compatible with the memory device 106 (e.g., a command that includes the parameters expected by the memory device 106).

At 210, the location change command is sent from the CPU memory controller 112 to the memory device controller 118. In one embodiment, the location change command may be sent over the same interface as other commands (e.g., read, write, refresh) sent to the memory device 106. For example, the command set of a DDR-based interface could be extended to include the location change command. In another embodiment, the location change command may be sent over an interface (e.g., SMBus) that is different from the interface (a DDR-based interface) used to send the other commands.

After receiving the location change command, the memory device controller 118 determines which mapping entries of the address translation engine are affected by the location change command and also determines new mapping values for the affected entries (collectively referred to herein as “address remap information”) at 212. At 214, the address remap information is sent to the address translation engine 120 which effects the changes to the mapping entries at 216. At 218, the address translation engine 120 provides an indication that the address remapping is complete (in other embodiments the memory device controller 118 may assume that the operation completed successfully after a predetermined period of time has passed or if no error is received after a predetermined period of time). At 220, the memory device controller may provide an indication that the location change command has been completed to the CPU memory controller 112 (alternatively, the CPU memory controller 112 may assume that the command completed successfully after a predetermined period of time has passed or if no error is received after a predetermined period of time). At 222, the CPU memory controller 112 may provide an indication that the location change command has been performed to the operating system 202 (alternatively, the operating system 202 may assume that the command was completed successfully after a predetermined period of time has passed or if no error is received after a predetermined period of time).

The flow described in FIG. 2 is merely representative of operations and communications that may occur in particular embodiments. In other embodiments, additional operations may be performed or additional communications sent among the components of system 100. Various embodiments of the present disclosure contemplate any suitable signaling mechanisms for accomplishing the functions described herein. Some of the operations illustrated in FIG. 2 may be repeated, combined, modified or deleted where appropriate. Additionally, operations may be performed in any suitable order without departing from the scope of particular embodiments.

FIG. 3 illustrates an example state of a memory device 106 prior to receiving a location change command in accordance with certain embodiments. In the embodiment depicted, externally addressable address space 302 and physical address space 306 are included within memory device 106 for explanatory purposes and may but do not necessarily correspond to a physical construct within memory device 106 (e.g., these address spaces may be implemented via other elements of the memory device, such as memory 116 and memory device controller 118).

In the embodiment depicted, memory device 106 includes an external interface 304, which may represent any suitable memory communication interface, such as any of the communication interfaces described above. The externally addressable address space 302 is exposed through the external interface 304 to a device (e.g., CPU memory controller 112 or I/O controller) coupled to the memory device 106 through the external interface 304. As depicted, the externally addressable address space 302 includes two allocated memory regions A1 and A2. A1 spans from memory address a (of the externally addressable address space 302) to memory address b and A2 spans from memory address c to memory address d. Accordingly, the largest contiguously addressable memory region available in the externally addressable address space 302 is the region from memory address d to memory address e.

The memory region A1 of the externally addressable address space is mapped to the memory region A1 of the physical address space 306 via one or more mapping entries 308A of address translation engine 120. Similarly, the memory region A2 of the externally addressable address space is mapped to the memory region A2 of the physical address space 306 via one or more entries 308B of the address translation engine. In the embodiment depicted, the memory region A1 of the physical address space 306 spans from physical memory address a1 to physical memory address b1 while the memory region A2 spans from physical memory address c1 to physical memory address d1.

A mapping entry 308 includes an indication 310 of an address in the externally addressable address space 302 and an indication 312 of a corresponding address in the physical address space 306. For example, mapping entry 308A includes an indication 310A of memory address a and an indication 312A of memory address a1, while mapping entry 308B includes an indication 310B of memory address c and an indication 312B of memory address c1. An indication of a memory address may be expressed in any suitable manner, such as an absolute memory address or a relative memory address (e.g., an offset that is relative to an absolute memory address indicated in another mapping entry 308 or other absolute memory address). In various embodiments, an indication of an address of a mapping entry may be explicitly stored or may be inferred based on the location of the mapping entry 308 within an array or other data structure. For example, the first element of an array may correspond to a first physical address of the physical address space 306 and may store an indication of a corresponding address in the externally addressable address space 302, the second element of the array may correspond to a second physical address (which could be the next largest physical address or the physical address of the next page, block, or other logical aggregation of memory cells) and may store an indication of a corresponding address in the externally addressable address space 302, and so on.

As alluded to above, the mapping between a region of externally addressable address space 302 and a region of physical address 306 may be stored in one or more mapping entries 308. In particular embodiments, address translation engine 120 includes a fixed number of mapping entries 308. In such embodiments, a mapping entry may be created for each physical address, for the first physical address of each page of memory, for the first physical address of each block of memory, or for the first physical address of each of a different logical grouping of memory. As one example, memory 116 may be divided into pages (e.g., of 4 Kilobytes each), and each page may have an associated mapping entry 308 with an indication 312 of a physical address of the start of the page and an indication 310 of a corresponding address in the externally addressable address space 302. In such an embodiment, the mapping for a region of memory would be provided by a number of mapping entries that is equal to the number of pages in the region of memory. Similarly, if a mapping entry 308 corresponds to another logical grouping, the mapping for a region of memory may be provided by a number of mapping entries that is equal to the number of units of the particular logical grouping in the region of memory.

In another embodiment, address translation engine 120 includes a dynamic number of mapping entries 308. For example, in order to store the mapping between regions, one mapping entry could be created to map the start addresses of the regions (e.g., as depicted by mapping entry 308a) and another mapping entry may be created to map the end addresses of the regions (e.g., an additional mapping entry could map memory address b to memory address b1). In an alternative embodiment, a single mapping entry mapping the start or end of the region could be used along with a stored value indicating the length of the region. In such embodiments, address mappings for addresses within the region of data could be calculated dynamically based on the mapping entry for the start or end address and an offset indicating where (with respect to the start or end address) in the region the target address is located. Accordingly, in some embodiments, only one or two mapping entries would be created for each allocated memory region. Although various examples have been provided, the address translation engine 120 may include any suitable number of mapping entries that map the externally addressable address space 302 to the physical address space 306 in any suitable manner.

As described earlier, the largest unallocated contiguously addressable memory region in externally addressable address space 302 spans from address d to address e. If the operating system identifies a request to allocate a contiguously addressable memory region that is larger than e−d, the operating system may issue a location change command in order to accommodate the request (assuming that enough unallocated memory is available to fulfill the request). As an example, the command may instruct memory device 106 to move the region A2 within the externally addressable address space to start at the end of the region A1.

FIG. 4 illustrates an example state of the memory device 106 after the location change command has been processed in accordance with certain embodiments. In various embodiments, the movement within the externally addressable address space 302 may be accomplished by changing the mapping in each mapping entry 308 that includes indications to addresses within the region of the externally addressable address space that is to be moved (i.e., from c to d) and each mapping entry 308 identifying addresses within the new region (i.e., from b+1 to b+1+d−c). For simplicity's sake, only the remapping of a single mapping entry is depicted. That is, after the remapping, the indication 310B of the address of mapping entry 308B now refers to address b+1 instead of address c. In various embodiments, other mapping entries may be updated in a similar manner to effectuate the remapping of the entire A2 region and the region that was displaced by the A2 region. In various embodiments, the region (or regions) displaced by the region that was moved may be moved within the externally addressable address space 302 to the region previously occupied by the region that was moved.

In the embodiment depicted, the memory region A2 is now addressable via the externally addressable address space 302 using the addresses b+1 to b+1+d−c, even though the physical location of the underlying data (A2 DATA) has not changed as evidenced by the lack of change in the physical address space 306. After the movement of the region A2 within the externally addressable address space 302, the largest unallocated contiguously addressable memory region is e−(b+1+d−c), that is, the region from the end of A2 to the end of the externally addressable address space 302. Accordingly, the hypothetical request introduced above that requested allocation of a contiguously addressable memory region that is larger than e−d may now be fulfilled.

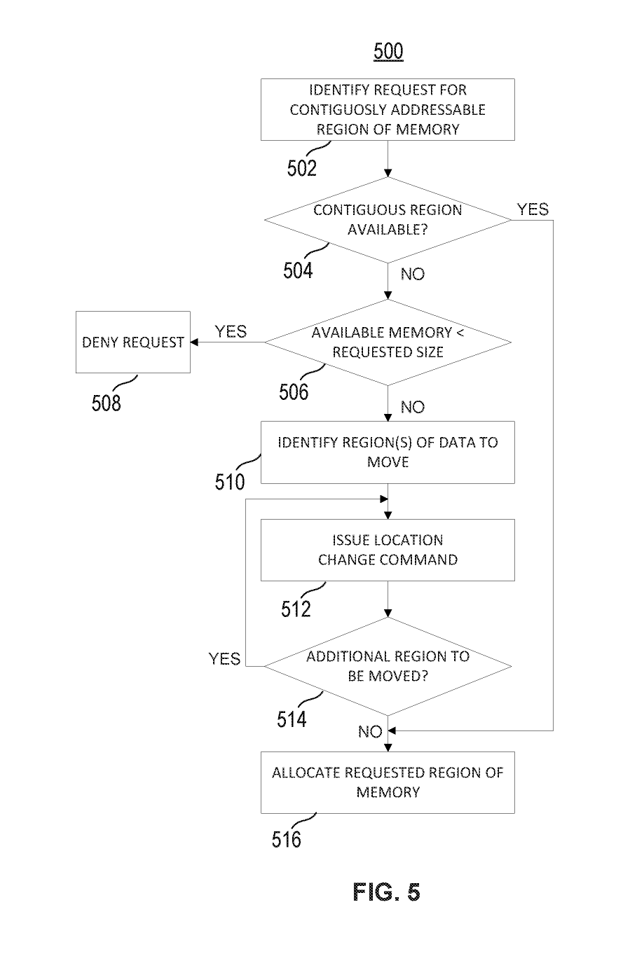

FIG. 5 illustrates an example flow 500 for issuing a series of change location commands in accordance with certain embodiments. The flow may be performed by any suitable hardware and/or software, such as an operating system executed by processor 108 or other application that has access to the externally addressable address space of a memory device 116. At 502, a request for a contiguously addressable memory region is identified. At 504, it is determined whether a contiguously addressable region large enough to satisfy the request is available in the externally addressable address space. If such a region exists, the requested region is allocated at 516. If no such region exists, it is determined at 506 whether the amount of memory available for allocation is less than the size of the contiguous region in the request. In a particular embodiment, the sizes of the unallocated regions of memory in the externally addressable address space may be added together and the resulting sum compared to the size of the requested contiguous region. If the available memory is less than the requested size, the request is denied at 508.

If the available memory is greater than the requested size, one or more regions of data are identified for remapping at 510. Such regions may be identified in any suitable manner. For example, in one embodiment, the identified regions include each region of data that should be moved within the externally addressable address space in order to make the various allocated regions contiguous with each other so as to maximize the size of an unallocated contiguously addressable memory region in the externally addressable address space. In another embodiment, the identified regions are selected so that the minimum number of regions are to be moved in order to provide the requested contiguously addressable memory region. In other embodiments, the regions may be identified using other methods.

At 512, a location change command is issued for a region identified at 510, resulting in the remapping of that memory region. At 514, it is determined whether at least one additional region is to be moved within the externally addressable address space. If so, another location change command is issued at 512. If not, the contiguously addressable memory region is allocated at 516 in accordance with the request.

Some of the operations illustrated in FIG. 5 may be repeated, combined, modified or deleted where appropriate, and additional operations may be added to the flow. As one example, in certain embodiments, a single location change command may specify multiple regions (and associated parameters) to be moved and thus all of the identified regions could be included in a single location change command sent to the memory device 106. Additionally, operations may be performed in any suitable order without departing from the scope of particular embodiments.

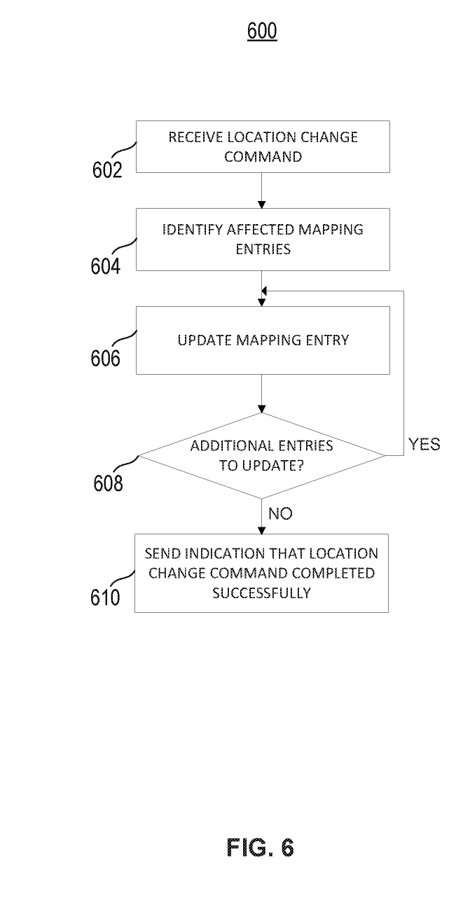

FIG. 6 illustrates an example flow 600 for processing a command to change a location of data within the externally addressable address space in accordance with certain embodiments. The various operations of flow 600 may be performed by any suitable logic of memory device 106, such as memory device controller 118 and/or address translation engine 120.

At 602, a location change command is received. At 604, mapping entries affected by the location change command are identified. At 606, a mapping entry of the address translation engine 120 is modified, e.g., by changing the indication 310 of the address of the externally addressable address space 302 or the indication 312 of the corresponding address of the physical address space 306. At 608 it is determined whether additional mapping entries are to be updated. If so, another mapping entry is updated at 606. If not, an indication that the location change command completed successfully is sent (e.g, to CPU 102).

Some of the operations illustrated in FIG. 6 may be repeated, combined, modified or deleted where appropriate, and additional operations may be added to the flow. Additionally, operations may be performed in any suitable order without departing from the scope of particular embodiments.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

“Logic” (e.g., as may be used to implement various components such as processor 108, I/O controller 110, CPU memory controller 112, memory device controller 118, address translation engine 120, memory modules 122, external interface 304, or other components of system 100 or as found in other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Various embodiments may provide an apparatus, a system, hardware- and/or software-based logic, or a non-transitory machine readable medium (including information to represent structures, when manufactured, to be configured) to comprise a memory device controller to receive a command comprising an identification of a region of data stored in a memory and a request to change a location of the region of data; and request the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

In at least one example, the command is to be generated by an operating system that addresses the memory via the externally addressable address space. In at least one example, the identification of the region of data comprises one or more addresses of the externally addressable address space. In at least one example, the identification of the region of data comprises a length of the region of data. In at least one example, the command further comprises an identification of a location within the externally addressable address space to which the location of the region of data should be changed. In at least one example, the apparatus further comprises the memory. In at least one example, the apparatus is further to comprise an address translation engine to maintain the plurality of entries mapping the externally addressable address space of the memory to the physical address space of the memory; and modify the at least one entry of the plurality of entries in response to the request from the memory device controller. In at least one example, the apparatus has a Dual In-line Memory Module (DIMM) form factor. In at least one example, the apparatus is to interface with a central processing unit through a double data rate (DDR)-based interface. In at least one example, an entry of the plurality of entries is to map a page of data of the memory between the externally addressable address space of the memory to the physical address space of the memory.

Various embodiments may provide a method comprising receiving a command comprising an identification of a region of data stored in a memory and a request to change a location of the region of data; and requesting the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

In at least one example, the command is to be generated by an operating system that addresses the memory via the externally addressable address space. In at least one example, the identification of the region of data comprises one or more addresses of the externally addressable address space. In at least one example, the identification of the region of data comprises a length of the region of data. In at least one example, the command further comprises an identification of a location within the externally addressable address space to which the location of the region of data should be changed. In at least one example, the method further comprises maintaining the plurality of entries mapping the externally addressable address space of the memory to the physical address space of the memory; and modifying the at least one entry of the plurality of entries in response to the request from the memory device controller. In at least one example, an entry of the plurality of entries is to map a page of data of the memory between the externally addressable address space of the memory to the physical address space of the memory. In at least one example, the method further comprises identifying a request to allocate a memory region of a particular size within the externally addressable address space; determining that the largest available contiguously addressable memory region in the externally addressable address space is smaller than the particular size; and generating the command in response to the request to allocate the memory region of the particular size. In at least one example, the command identifies a plurality of memory regions to be moved within the externally addressable address space. In at least one example, the method further comprises interfacing with a central processing unit through a double data rate (DDR)-based interface. In at least one example, the method further comprises receiving a read command through a communication interface that is different from a communication interface through which the command comprising the identification of the region of data is received.

Various embodiments may provide a system to comprise an operating system to be executed by a processor; a memory device comprising a memory and a memory device controller to receive a command from the operating system, the command comprising an identification of a region of data stored in a memory and a request to change a location of the region of data; and request the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

In at least one example, wherein the operating system is to identify a request to allocate a memory region of a particular size within the externally addressable address space; determine that the largest available contiguously addressable memory region in the externally addressable address space is smaller than the particular size; and generate the command in response to the request to allocate the memory region of the particular size. In at least one example, the identification of the region of data comprises one or more addresses of the externally addressable address space. In at least one example, the identification of the region of data comprises a length of the region of data. In at least one example, the command further comprises an identification of a location within the externally addressable address space to which the location of the region of data should be changed.

Various embodiments may provide an apparatus comprising means for receiving a command comprising an identification of a region of data stored in a memory and a request to change a location of the region of data; and means for requesting the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

In at least one example, the command is to be generated by an operating system that addresses the memory via the externally addressable address space. In at least one example, the identification of the region of data comprises one or more addresses of the externally addressable address space. In at least one example, the identification of the region of data comprises a length of the region of data. In at least one example, the command further comprises an identification of a location within the externally addressable address space to which the location of the region of data should be changed.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a memory device controller to:
receive a command comprising an identification of a region of data stored in a memory and a request to change a location of the region of data; and
request the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

2. The apparatus of claim 1, wherein the command is to be generated by an operating system that addresses the memory via the externally addressable address space.

3. The apparatus of claim 1, wherein the identification of the region of data comprises one or more addresses of the externally addressable address space.

4. The apparatus of claim 1, wherein the identification of the region of data comprises a length of the region of data.

5. The apparatus of claim 1, wherein the command further comprises an identification of a location within the externally addressable address space to which the location of the region of data should be changed.

6. The apparatus of claim 1, further comprising the memory.

7. The apparatus of claim 1, further comprising an address translation engine to:
maintain the plurality of entries mapping the externally addressable address space of the memory to the physical address space of the memory; and
modify the at least one entry of the plurality of entries in response to the request from the memory device controller.

8. The apparatus of claim 1, wherein the memory has a Dual In-line Memory Module (DIMM) form factor.

9. The apparatus of claim 1, wherein the memory is to interface with a central processing unit through a double data rate (DDR)-based interface.

10. The apparatus of claim 1, wherein an entry of the plurality of entries is to map a page of data of the memory between the externally addressable address space of the memory to the physical address space of the memory.

11. A method comprising:
receiving a command comprising an identification of a region of data stored in a memory and a request to change a location of the region of data; and
requesting the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

12. The method of claim 11, wherein the command is to be generated by an operating system that addresses the memory via the externally addressable address space.

13. The method of claim 11, wherein the identification of the region of data comprises one or more addresses of the externally addressable address space.

14. The method of claim 11, wherein the identification of the region of data comprises a length of the region of data.

15. The method of claim 11, wherein the command further comprises an identification of a location within the externally addressable address space to which the location of the region of data should be changed.

16. A system to comprise:
a processor to execute an operating system;
a memory device comprising a memory; and
a memory device controller to:
receive a command from the operating system, the command comprising an identification of a region of data stored in a memory and a request to change a location of the region of data; and
request the modification of at least one entry of a plurality of entries, the plurality of entries to map an externally addressable address space of the memory to a physical address space of the memory, the modification of the at least one entry to change a mapping of the region of data between the externally addressable address space and the physical address space without moving the region of data within the memory.

17. The system of claim 16, wherein the operating system is to:
identify a request to allocate a memory region of a particular size within the externally addressable address space;
determine that the largest available contiguously addressable memory region in the externally addressable address space is smaller than the particular size; and
generate the command in response to the request to allocate the memory region of the particular size.

18. The system of claim 16, wherein the identification of the region of data comprises one or more addresses of the externally addressable address space.

19. The system of claim 16, wherein the identification of the region of data comprises a length of the region of data.

20. The system of claim 16, wherein the command further comprises an identification of a location within the externally addressable address space to which the location of the region of data should be changed.

21. The system of claim 16, further comprising one or more of: a battery communicatively coupled to the processor, a display communicatively coupled to the processor, or a network interface communicatively coupled to the processor.
